(19) United States
(12) Patent Application Publication
(10) Pub. No.: US 2006/0199146 A1
(43) Pub. Date: Sep. 7, 2006

(54) Method of transferring power and data via an inductive link

(75) Inventors: Stan Mandelkern, Teaneck, NJ (US); Iouri Kazarov, Wayne, NJ (US)

Correspondence Address: FITZPATRICK CELLA HARPER & SCINTO, 30 ROCKEFELLER PLAZA, NEW YORK, NY, 10112, US

(73) Assignee: SCHICK TECHNOLOGIES, Long Island City, NY (US)

(21) Appl. No.: 11/068,164

(22) Filed: Mar. 1, 2005

(51) Int. Cl. A61C 3/00

(52) U.S. Cl. 433/52

(57) ABSTRACT

An apparatus and method for transferring data and power through an electromagnetic induction link is provided. The link operates with high efficiency to allow its use in scenarios with limited available power, such as with a computer's USB port. When data is transferred, redundant frequency encoded pulses are used. When power is transferred, a continuous waveform is used, and the-+transferred power may be used to provide power to a variety of devices and components and to recharge batteries.

### BACKGROUND OF THE INVENTION

1. Field of the Invention

This invention relates generally to the transfer of power and data, and more particularly to an apparatus and method for transferring power and data using an electromagnetic induction link.

2. Description of the Related Art

Many electrical devices transmit energy and data to other devices. The transfer of energy is often accomplished using inductive coupling.

The use of inductive coupling (link) technology to transfer energy from one circuit to another through a shared magnetic field, is well known. In such technology, one circuit causes or induces an electrical or magnetic force on another circuit through, for example, proximately located inductive coils. A variety of devices, including medical, dental and consumer electronics, currently utilize an inductive link as a method of transferring power and/or charging a secondary battery, such as recharging an on-board battery supply. Because the transfer of energy from one device to another using an inductive link is accomplished without the devices having to be in actual physical contact with each other, the devices can be completely sealed, eliminating the need for exposed electrical contacts and allowing the housings of the devices to be more aesthetically pleasing.

An example of an inductive link technology system is provided in U.S. Patent Publication No. 2003/0103039, which describes a system for providing power to a peripheral device, such as a computer mouse, from a computer during the normal operation of the peripheral device. The system includes a base for creating a magnetic field, as well as functioning as a mouse pad. When the computer mouse, which has an inductive coil, is placed on the mouse pad, in the magnetic field, an inductive link is created and a voltage is induced into the computer mouse. The inductive link is used to transfer only power from the mouse pad to a rechargeable battery in the computer mouse. While this method provides means for utilizing an inductive link, the method has some drawbacks. Most notably, the inductive link is not able to transfer data from the computer mouse to the mouse pad or the computer connected to the mouse pad. In fact, data transfer occurs in the wireless mouse via a secondary infrared or radio frequency link.

The transfer of data between electrical devices is typically accomplished via a flexible cable. In many systems, however, wireless communication technology is employed, via a radio frequency (RF) waveform. Systems used in the medical and dental imaging fields, for example, often incorporate portable units (hand pieces) that transmit and receive data to/from a base station in a wireless fashion. Wireless communication may be preferable to cables for a number of reasons. For example, in the medical and dental fields, use of cables and/or wires may limit placement of sensors or make the placement of sensors cumbersome, possibly creating a hazard of having exposed electrical contacts, as well as tripping hazards.

Because radio frequency environments are often crowded with other signals and noise sources, multiple user-selectable channels are often utilized for the communication. To improve the performance of an RF wireless system, it may be preferable for the user to switch between the available channels to find an optimum channel for use in the radio frequency environment. Accordingly, both the base station and the portable unit must be on the same channel and in proper communication to even be able to transmit “channel” data. To ensure the base station and the portable unit are on the same channel, the portable unit is returned to the base station which provides means for setting both the base station and portable unit to the same channel.

The use of a base station has been widely employed in technology systems. U.S. Pat. No. 6,527,442 describes, for example, a holder for an x-ray sensitive dental sensor that doubles as a base station. When the sensor is in the holder, the holder provides means to charge a sensor and download data. One of the means by which the sensor may be charged is through an inductive link. However, data transfer occurs through alternative means, such as through an electrical cable, or a wireless (e.g., Bluetooth) interface. In this case as well as in others, it is possible that the volume of data associated with an x-ray imaging array may be too large to be practical for inductive transfer. For example, a sensor may collect data in excess of 10 MB of data, however, a typical inductive link is not capable of transmitting more than 5 kB in 5 seconds.

Because inductive charging is a common technique for a variety devices in a plurality of technology areas and because of the issues associated with the prior art techniques for wireless data transfer, discussed above, there exists a need for utilizing inductive link technology as a means for transferring both power and data between devices.

### SUMMARY OF THE INVENTION

One object of the present invention is to provide a method of transferring data and power through an electromagnetic inductive link.

Another object of the present invention is to provide a method of providing communication between a wireless dental camera and a base station.

In one embodiment of the present invention, a data and power transfer system comprises a data and power transmitter for transmitting data and power, and a data and power receiver for receiving the transmitted data and power. The data and power is transmitted between the data and power transmitter and the data and power receiver via an electromagnetic induction link.

In an other embodiment of the present invention, a method is provided for transferring data and power from one device to another device using an electromagnetic induction link. The method is carried out by generating a signal, where the signal is a continuous waveform when transferring power and redundant frequency encoded pulses when transferring data. The method also includes amplifying the signal, providing a magnetic field using the amplified signal, inducing the amplified signal onto the other device, and processing the induced amplified signal. The processing includes rectifying and stabilizing the induced amplified signal to produce a direct current voltage when the signal is a continuous waveform, and creating a series of clean digital pulses when the signal is redundant frequency encoded pulses. The method further includes charging at least one of a battery and a variety of devices and components using the direct current voltage, and interpreting information residing in the series of clean digital pulses.

In yet another embodiment of the present invention, a method of communicating between a wireless dental camera and a base station of an intra-oral dental camera system is provided. The method includes generating a signal in the base station, transmitting the generated signal from the base station to the wireless dental camera using an electromagnetic inductive link, and receiving the signal in the wireless dental camera. The signal is a continuous square wave when transferring power and redundant frequency encoded pulses when transferring data.

In another embodiment of the present invention, a system for transmitting data and power is provided. The system includes a generator for generating a signal, a processor for processing the generated signal, and a transmitter for transmitting the signal using an electromagnetic induction link. The generated signal is a continuous waveform when power is being transmitted and redundant frequency encoded pulses when data is transmitted.

In still another embodiment of the present invention, a system for receiving data and power is provided. The system includes a receiver for receiving a signal transmitted using an electromagnetic induction link, a charging unit for charging a variety of devices and components when the received signal represents power, and a signal processor for processing the received signal when the received signal represents data.

These and other objects, features and advantages will be apparent from the following description of the preferred embodiments of the present invention.

### BRIEF DESCRIPTION OF THE DRAWINGS

The invention present invention will be more readily understood from a detailed description of the preferred embodiments taken in conjunction with the following figures.

FIG. 1 is a block level illustration of one embodiment of a charging and data transfer unit.

FIG. 2 is a block level illustration of one embodiment of a battery and receiving data unit.

FIG. 3 is an illustration of one embodiment of the wireless intra-oral dental camera seated in the base station of the present invention.

FIG. 4 is an illustration a base unit of a wireless intra-oral dental camera.

FIG. 5 is an illustration of a camera hand piece of a wireless intra-oral dental camera.

FIG. 6 is a flowchart of the data transfer and charging sequences of one embodiment of the present invention.

### DETAILED DESCRIPTION OF THE PREFERRED EMBODIMENTS

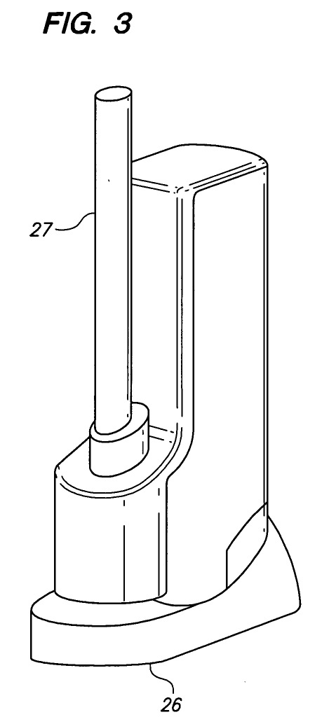

A preferred embodiment of a data and power transfer system utilizing an electromagnetic induction link (inductive link) technology in accordance with the present invention will now be described with reference to the figures. A particular application of the present invention, for example a wireless intra-oral dental camera, is shown in FIG. 3. In the case of the dental camera, a base station (26) transmits power and “channel” data, representing a wireless channel selection, to a camera hand piece (27). Of course, as would be apparent to those skilled in the art, the data may be used to achieve alternative means, as long as the inductive link were properly rectified, stabilized, and the duration of transfer meets the need of the intended application.

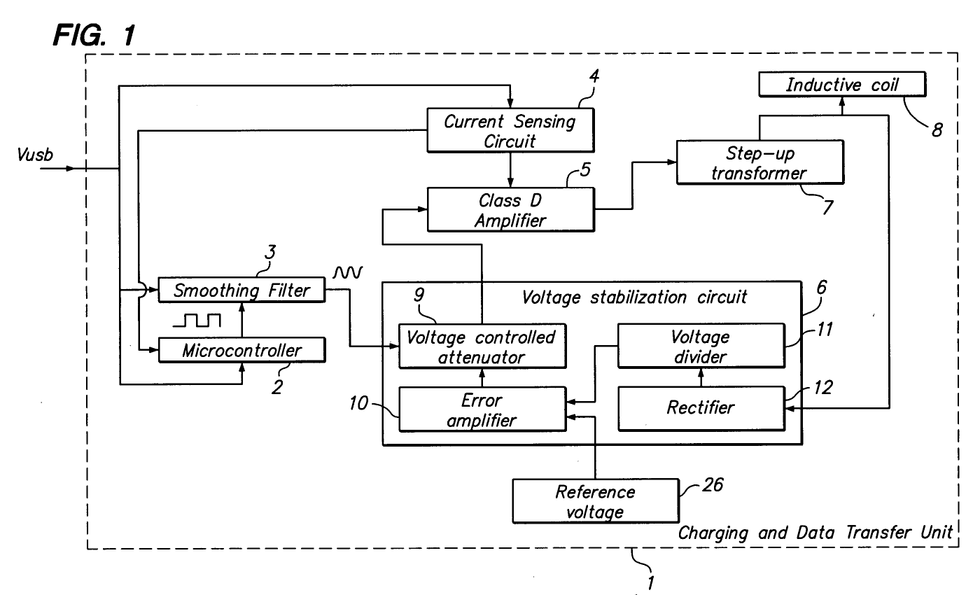

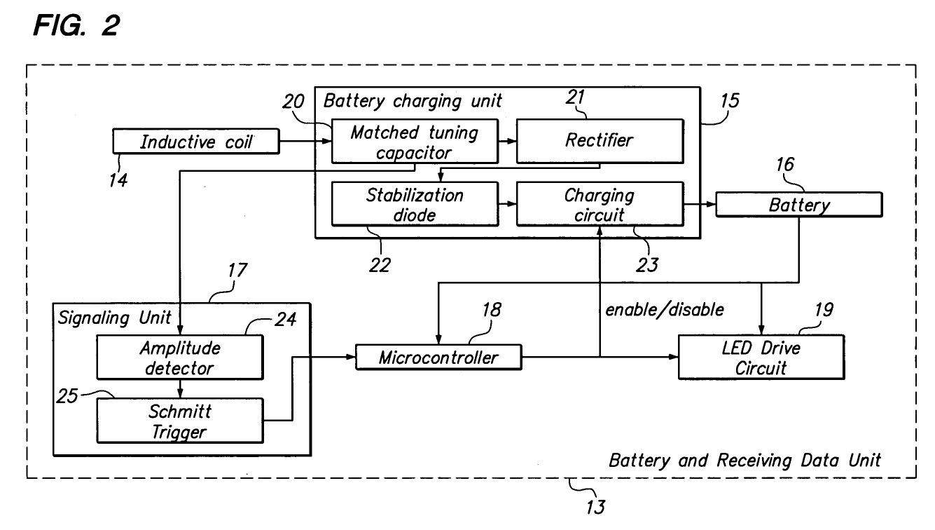

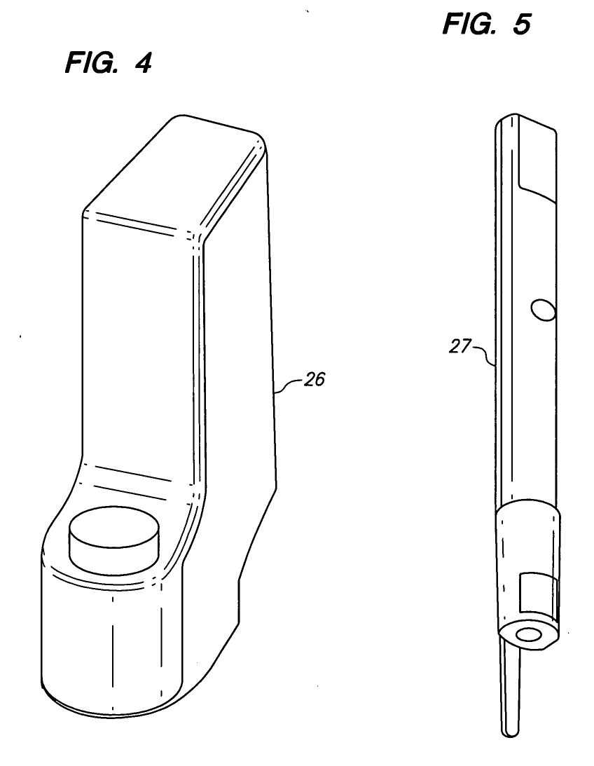

In a preferred embodiment of the present invention the data and power transfer system includes a charging and data transfer unit (FIG. 1) and a battery and receiving data unit (FIG. 2). The charging and data transfer unit may be housed, for example, in the base station (26) of the wireless intra-oral dental camera depicted in FIG. 4, and the battery and receiving data unit may be housed, for example, in the camera hand piece (27) depicted in FIG. 5. When the base station (26) and the camera hand piece (27) are in close proximity with each other, such as the camera hand piece (27) being “seated” in the base station (26), an inductive link is formed.

FIG. 1 is a block level illustration of the charging and data transfer unit (1). The charging and data transfer unit (1) operates in three modes, a charging mode, a data transfer mode, and an idle mode. As can be seen, the charging and data transfer unit (1) includes a microcontroller (2), a smoothing filter (3), a current sensing circuit (4), a class D amplifier (5), a voltage stabilization circuit (6), a step-up transformer (7), and an inductive coil (8).

The efficiency of the charging and data transfer unit is sufficient that it can be operated with the power available from a USB interface (V_{usb}).

The current sensing circuit (4) of the charging and data transfer unit (1) enables the data and power transfer system, by sending a signal to the microcontroller (2), indicating that the data and charging sequence should commence. The signal is generated in response to a detection of an event, such as when a hand piece is “seated” in a base station.

Upon receiving the signal from the current sensing circuit (4), the microcontroller (2) communicates a continuous square waveform that is used to both charge a rechargeable battery and transmit data. When the charging and data transfer unit is in the charging mode, the communicated waveform is a constant square wave. When the charging and data transfer unit is operating in the data transfer mode, the microcontroller (2) communicates redundant frequency encoded pulses. The pulses may be transmitted multiple times to assure data reliability. Of course, as would be apparent to those skilled in the art, the waveforms communicated by the microcontroller (2) in either the charging mode or the data transfer mode can take a multitude of alternative configurations, as long as the inductive link is properly rectified, stabilized, and the duration of the data transfer meets the requirements of the intended application.

The waveform exiting the microcontroller is passed through a smoothing filter (3) to reduce electromagnetic interference. The output of the smoothing filter (3) is a sinusoidal waveform. In an alternative embodiment, an autonomous drive oscillator (not shown) may be used. This may be preferable if the distance between the microcontroller (2) and the smoothing filter (3) is large. A large distance between the microcontroller (2) and the smoothing filter (3) may negatively impact the performance of the system. In the case of a densely populated circuit board, a distance of less than one inch between the microcontroller (2) and the smoothing filter (3) may be preferable.

The filtered signal from the smoothing filter (3) is eventually conveyed to a high efficiency class D amplifier (5), and then to a step-up transformer (7) which may perform a magnification, for example, by a factor of two. The amplified signal from the step-up transformer (7) is used to provide a magnetic field on an inductive coil (8).

The filtered signal exiting the smoothing filter (3) is passed through a voltage stabilization circuit (6) which serves to stabilize the voltage at the output of the step-up transformer (7). The voltage stabilization circuit (6) includes a voltage controlled attenuator (9), an error amplifier (10), a voltage divider (11), and a rectifier (12). The voltage stabilization circuit forms an indirect feedback loop with the class D amplifier (5). In the voltage stabilization circuit, the rectifier (12) converts AC voltage to DC, the voltage divider (11) generates the desired output voltage, and the error amplifier (10) compares the desired output voltage with a reference voltage (26). The signal is then attenuated by the voltage control attenuator (9) according to the error amplifier (10) output voltage. The voltage stabilization circuit (6) also allows the current sensing circuit (4) to perform event detection. This occurs when voltage within the voltage stabilization circuit (6) decreases the signal to the class D amplifier (5) which leads to a lower idle power supply current. This reduction in current is identified in the current sensing circuit (4).

FIG. 2 is a block level illustration of a battery and receiving data unit (13). The battery and receiving data unit (13) includes an inductive coil (14), a battery charging unit (15), a battery (16), a signaling unit (17), a microcontroller (18) and an LED drive circuit (19). The battery charging unit (15) includes a matched tuning capacitor (20), a rectifier (21), a stabilization diode (22) and a charging circuit (23).

The amplified signal (AC voltage) from the charging and data transfer unit (1), used to provide the magnetic field on the inductive coil (8), is induced onto the battery and receiving data unit (13) through the inductive coil (14). The received amplified signal is passed through a matched tuning capacitor (20) of the battery charging unit (15). Because the data and power transfer system operates under varied conditions, it is important that the matched tuning capacitor (20) is selected to match the inductive coil. Selection of the capacitor and inductive coil can be done empirically using principles that are well known to those skilled in the art. If not properly selected, the system may become unstable.

When the data and power transfer system is in the data transfer mode, the received redundant frequency encoded pulses signal is routed from the matched tuning capacitor (20) to the signaling unit. The signaling unit includes an amplitude detector (24) and a Schmitt trigger (25). Together, these components, the amplitude detector (24) and the Schmitt trigger (25), create a series of clean digital pulses representing the transferred data, such as “channel data”. The clean digital pulses are conveyed to the microcontroller (18) so that the data may be interpreted.

When the data and power transfer system is operating in the charging mode, the inductive link will typically charge a battery or provide primary power to a secondary unit, such as a LED drive circuit (19). The received power, which is outputted from the matched tuning capacitor (20), is communicated to the rectifier (21) which converts the AC voltage to a DC voltage. The received power is further stabilized by the stabilization diode (22), which insures also that when the inductive link is activated the current increases in the aforementioned current sensing circuit (4). The output of the stabilization diode (22) is inputted to the charging circuit (23) which provides power to, for example, a 4.2V lithium ion rechargeable battery. The power from the charging circuit (23) may also be used to provide power to a variety of means/components, including, for example, LEDs of the hand piece in the intra-oral camera through the LED drive circuit (19).

In the case of the charging circuit (23) providing power to a battery, the charging circuit (23) monitors the amount of current being drawn by the battery (16). As is customary with lithium ion batteries, a decrease in the current being drawn during a charging sequence indicates that the battery is nearly fully charged. Thus, when the charging circuit (23) detects that the battery is fully charged, the data and power transfer system is placed into the idle mode. This is done when the charging circuit (23) shuts off, after having detected that the battery is fully charged. When the charging circuit shuts off, the consumed current is reduced. The current sensing circuit (4) detects the reduced current flow and places the data and power transfer system into the idle mode. Additionally, if the lithium ion battery voltage falls below a nominal value, as would occur if it were not in use for a prolonged period, the charging circuit (23) provides a trickle charge, a continuous constant-current charge at a low rate, to the battery (16) prior to the normal charging sequence. 1

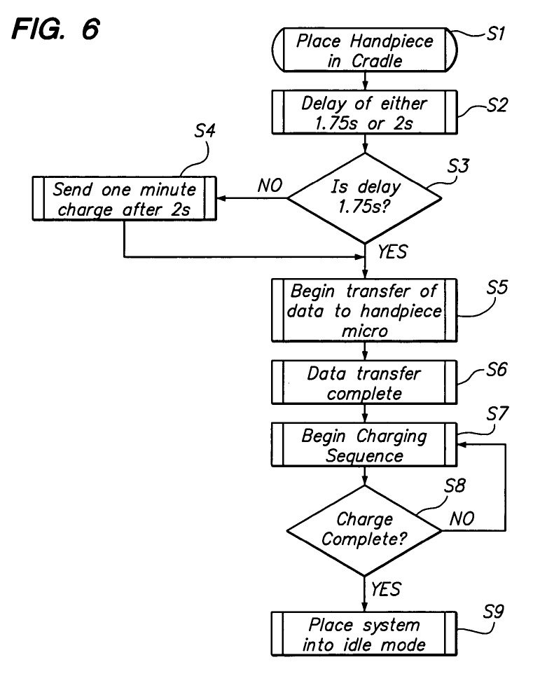

FIG. 6 is a flowchart of the data transfer and charging sequences of the present invention. As discussed previously, the data and power transfer system manages both power and data. The operational flow of data and power occurs sequentially. After the inductive link is established, for example, the camera hand piece is seated into the base station (S1), there is a delay of either 1.75 seconds or 2 seconds before power or data transfer occurs (S2). During this delay, the microcontroller (18) of the battery and receiving data unit (13) sends a disable flag to the charging circuit (23), preventing the rectifier (21) from consuming current. If the microcontroller (18) sends the disable flag, data transfer occurs 1.75 seconds after the inductive link is established. However, if the power is completely depleted to the hand piece, this disabling flag cannot be sent. Instead, a one minute charging sequence to the battery to supply sufficient power for data transfer is performed after a delay of 2 seconds (S4). Data transfer proceeds either normally, 1.75 seconds after the inductive link is enabled, or otherwise following the aforementioned one minute charging sequence (S5). It should be noted, that while the data transfer link described is unidirectional in this case, it would be clear to those skilled in the art that the data transfer link may be designed to be bi-directional.

After the data transfer has been completed (S6), determined, for example, by counting the number of pulses of the redundant frequency encoded pulses transferred, the data and power transfer system is immediately placed into the charging mode, and a complete charging sequence is activated by the microcontroller (S7). Once the charging is complete (S8), the data and power transfer system is placed into the idle mode (S9), discussed previously.

It is understood that the above description and drawings are illustrative of the present invention and detail contained therein are not to be construed as limitations thereon. Changes in components, procedure and structure may be made without departing from the scope of the present invention as defined in the following claims.

1. A data and power transfer system, comprising:
a transmitter for transmitting data and power; and
a receiver for receiving the transmitted data and power,
wherein data and power is transmitted between said transmitter and said receiver via an electromagnetic induction link.

2. A data and power transfer system according to claim 1, wherein said transmitter includes:
a first microcontroller that at least generates a continuous waveform;
a smoothing filter that converts the continuous waveform generated by said microcontroller to a sinusoidal waveform, and reduces electromagnetic interference;
a current sensing circuit that enables the system;
an amplifier that amplifies the output of said smoothing filter;
a voltage stabilization circuit that stabilizes the output of said amplifier;
a step-up transformer that increases the voltage of the output from said amplifier; and
an inductive coil that creates a magnetic field transferring a voltage onto said receiver.

3. A data and power transfer system according to claim 1, wherein said receiver includes:
an inductive coil receives the voltage from said transmitter;
a battery charging unit that rectifies and stabilizes the transferred voltage and provides power to a variety of devices and components;
a signaling unit that creates a series of clean digital pulses from the transferred data;
a second microcontroller that interprets the transferred data;
an LED drive circuit that drives LEDs using the power supplied by said battery charging unit; and
a battery that receives power from battery charging unit.

4. A data and power transfer system according to claim 1,
wherein said transmitter is housed in a base station of a intra-oral wireless dental camera system, and
wherein said receiver is housed in a camera hand piece of a intra-oral wireless dental camera system.

5. A data and power transfer system according to claim 1, wherein said transmitter is powered by a USB connection.

6. A data and power transfer system according to claim 1, wherein data is transferred using redundant frequency encoded pulses.

7. A method of transferring data and power from one device to another device using an electromagnetic induction link, comprising:
generating a signal, wherein the signal is a continuous waveform when transferring power and redundant frequency encoded pulses when transferring data;
amplifying the signal;
providing a magnetic field using the amplified signal;
inducing the amplified signal onto the other device;
processing the induced amplified signal, wherein said processing includes rectifying and stabilizing the induced amplified signal to produce a direct current voltage when the signal is a continuous waveform, and creating a series clean digital pulses when the signal is redundant frequency encoded pulses;
charging at least one of a battery and a variety of devices and components using the direct current voltage; and
interpreting information residing in the clean digital pulse.

8. A method of providing communication between a wireless dental camera and a base station of an intra-oral dental camera system, comprising:
generating a signal in the base station;
transmitting the generated signal from the base station to the wireless dental camera using an electromagnetic inductive link; and
receiving the signal in the wireless dental camera.

9. A method according to claim 8, wherein the signal is a continuous waveform when transferring power and redundant frequency encoded pulses when transferring data.

10. A system for transmitting data and power comprising:
a generator for generating a signal;
a processor for processing the generated signal; and
a transmitter for transmitted the signal using an electromagnetic induction link,
wherein the generated signal is a continuous waveform when power is transmitted and redundant frequency encoded pulses when data is transmitted.

11. A system for receiving data and power comprising:
a receiver for receiving a signal transmitted using an electromagnetic induction link;
a charging unit for charging a variety of devices and components when the received signal represents power; and
a signal processor for processing the received signal when the received signal represents data.
